(19) United States
(12) Patent Application Publication
(10) Pub. No.: US 2026/0204150 A1
(43) Pub. Date: Jul. 16, 2026

(54) A SECURITY DEVICE

(71) Applicant: ESSENCE SECURITY INTERNATIONAL (E.S.I.) LTD., Herzlia Pituach (IL)

(72) Inventors: Mihael BERCOVICI, Shoham (IL); Ohad AMIR, Herzlia (IL); Jonathan Mark SCHNAPP, Tel Aviv (IL)

(21) Appl. No.: 19/132,801

(22) PCT Filed: Nov. 23, 2023
(86) PCT No.: PCT/IL2023/051207

§ 371 Date: May 24, 2025

(30) Foreign Application Priority Data
Nov. 24, 2022 (GB) 2217595.4

(51) Int. Cl. G08B 25/10; G08B 13/22; G08B 15/00; H04W 76/28

(52) U.S. Cl. CPC G08B 25/10; G08B 13/22; G08B 15/00; H04W 76/28

(57) ABSTRACT

A security device comprises a cellular modem and a sensor. The device is operable in a first mode in which there is a first maximum interval between successive times at which the modem is able to receive cellular communications. In response to satisfaction of a condition, the device operates in a second mode in which the modem is continuously able to receive cellular communications or in which there is a second maximum interval between times at which the modem is able to receive cellular communications, wherein the second maximum time is shorter than the first maximum time interval, and the device remains in second mode for a waiting period to enable receipt of an operator command via the cellular modem. The condition comprises that an operator requested arming state for the device that is stored on the device when the event is detected by the sensor is an armed state.

### RELATED APPLICATION/S

This application claims the benefit of priority of British Patent Application No. 2217595.4, filed on 24 Nov. 2022, the contents of which are incorporated herein by reference in their entirety.

### FIELD

The present disclosure is in the field of security devices having functionality to monitor an environment to detect a security threat in the environment, e.g. an intruder.

### BACKGROUND

Systems for use in providing a security function in a premises or other area of interest, often comprise a plurality of discrete security devices and a control hub, which is locally installed. In background examples, a security system can comprise a plurality of monitoring devices each connected to a control hub by means of electrical connections. This can involve significant effort and disruption for installation.

Security devices may have functionality to take one or more actions in response to an identified event representing a threat or possible threat. Such “response actions”, also referred to herein as “security response actions” may include verification actions or deterrent actions. A verification action may comprise any action comprising information gathering action from the environment to perform assess or enable performance of a security-related assessment of the scene, which may be used to verify that a threat is real (i.e. not a false positive) and/or that taking some further action in response to an alert is warranted. Examples may include, capturing a photo or video to observe a scene, operating a radar or other reflected wave measuring device, or recording audio. A deterrent action may comprise outputting one or more deterrents to deter a person from remaining in the environment. A deterrent action may comprise an audible or visible emission (e.g. a siren or flashing light). Additionally or alternatively the deterrent may comprise the outputting of one or more other deterrents that are neither visual or nor audio, such as a visible-light obscuring matter e.g. smoke, water vapour or other light-obscuring substance, or any other physiologically and/or psychologically influencing deterrent. Such other deterrents may provide a stronger level of deterrence than visual and/or audio deterrents. In the case of outputting of light obscuring substance, for example, the substance hinders visibility in the environment, deterring an intruder from remaining or advancing in the environment.

In order to avoid substantial disruption and cost of installation, security devices can be battery-powered and capable of establishing a local wireless connection with a locally installed control hub. However, the power consumption constraint associated with battery power can limit the capability of a security device, particularly if it is required to maintain a wireless connection. The control-hub may be custom-designed for this purpose, for example whereby each security device communicated with the control hub using a low-power communication protocol, such as a Low-Rate Wireless Personal Area Network (e.g. in accordance with IEEE 802.15.4) or the like. For some applications it may be desirable for a security device and/or a system that is based on a different wireless protocol. However, developing such devices, systems and protocols and/or the manner in which such protocols are employed can be challenging, particular where power consumption remains a constraint.

### BRIEF DESCRIPTION OF THE SEVERAL VIEWS OF THE DRAWING/S

FIG. 1 illustrates a security system in an embodiment;

FIG. 2 illustrates an example security device of the security system of FIG. 1;

FIG. 3 illustrates an example monitoring station of the security system of FIG. 1;

FIG. 4 illustrates an example user device of the security system of FIG. 1;

FIG. 5 illustrates an example server of the security system of FIG. 1;

FIG. 6 illustrates a conceptual diagram showing times depicting current consumption by a cellular modem, according to an example, while in various states when the security device of FIG. 1 is in a first mode of operation, in accordance with example embodiments disclosed herein;

FIG. 7 illustrates a conceptual diagram showing times depicting current consumption by a cellular modem, according to an example, while in various states when the security device of FIG. 1 is in a second mode of operation, in accordance with an embodiment;

FIG. 8A illustrates a conceptual diagram showing times depicting current consumption when a modem is in a Radio Resource Control (RRC) connected mode;

FIG. 8B illustrates a illustrates a conceptual diagram showing times depicting current consumption when a modem is in a Power Saving Mode (PSM);

FIG. 9 illustrates an example scenario causing the security device of FIG. 1 to switch from a first mode to a second mode, in an embodiment;

FIG. 10 illustrates another example scenario causing the security device of FIG. 1 to switch from a first mode to another mode in which the modem is in a communications mode, but immediately thereafter switch back to the first mode, in an embodiment; and

FIG. 11 illustrates a swim-lane diagram for an example operation of a security device and system containing the security device in accordance with the configuration of FIG. 1.

### DESCRIPTION OF EMBODIMENTS

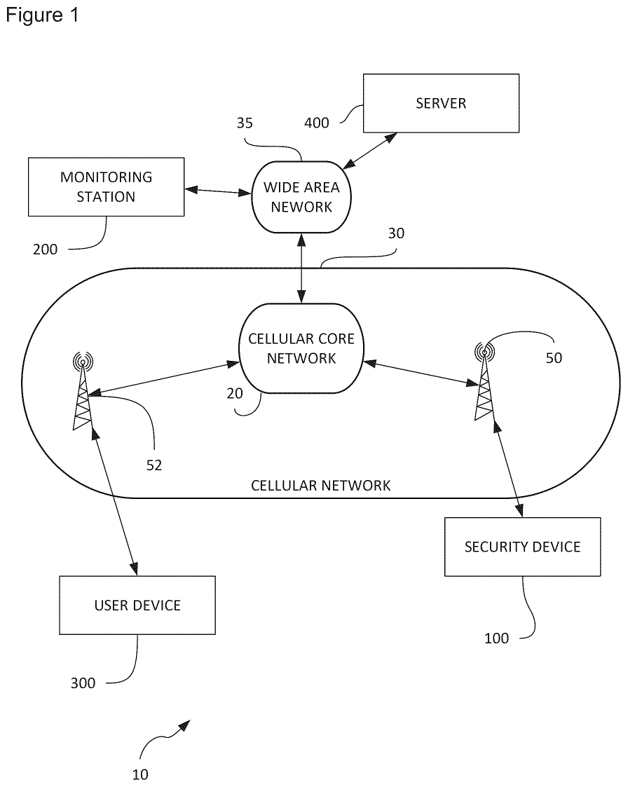

Various embodiments of the invention may be understood with reference to an example security system 10, as depicted in FIG. 1. The system 10 comprises a security device 100, installed in a premises, a server 400 and one or more operating nodes, which may comprise a monitoring station 200 and/or a user device 300. The security device 100, and in this example the user device 300, are each connectable to a wide area network (WAN) 35 which may be a packet switched network (e.g. the internet) via a cellular network 30. The server 400 and the monitoring station 200 are also connected to the WAN 35, by any means but in this example for illustrative purposes is depicted as a direct connection, as opposed to being via the cellular network 30.

The server 400 may comprise one or more application servers for (a) the security device 100 and (b) the monitoring station 200 and/or a user device 300, and may provide an interface between (a) the security device 100 and (b) the monitoring station 200 and/or a user device 300, for example by relaying information between them.

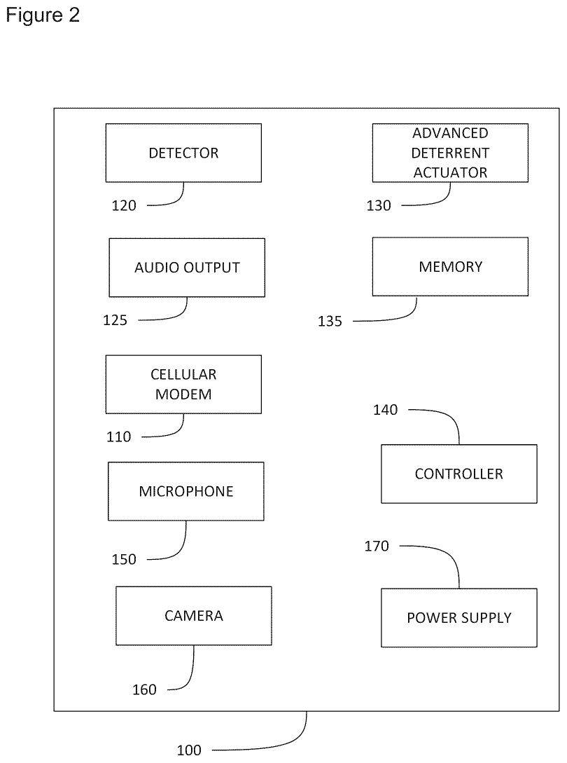

FIG. 2 shows a more detailed view of the security device 100. The security device 100, has a capability to monitor a scene for an event. The security device 100 may however be considered as a security response device as may be capable of a security response action, as defined herein. While the security device 100 may be a dedicated device for security, the reader will appreciate that the security device 100 may optionally have additional functions enabling it to also be used for non-security applications.

The security device has at least one detector 120 which provides a facility to detect an event that could be indicative of a security threat. The event could comprise for example an unauthorised person in a secured location, a vibration or other kinetic impulse commensurate with an attempt to gain entry to a secured location, or a sound indicative of an unauthorised intrusion. The detector may be a detector of electromagnetic radiation, an audio detector, magnetic detector for a door/window, or any other detector suitable for detecting an event that may be indicative of security threat.

The detector may be passive or active. A passive device generally detects incident energy imparted thereon from ambient conditions; an active device effects an emission and then determines a response to reflections of that emission back on the device. Such a detector, whether passive or active, may be used to detect motion.

In an example, the detector is an electromagnetic detector; in one example it is an infrared detector, which is preferably a passive infra-red detector.

If the detector is an active detector, it may be a doppler detector based on radio waves light or sound waves, and/or it may comprise a ranging function. Examples of devices with ranging facilities include Radar, Lidar and Sonar, which tend to include doppler functionality as well.

For the benefit of this specific example, the detector 120 may be taken to be a passive infrared (PIR) sensor.

The security device 100 comprises a cellular modem 110 capable of establishing two-way communication, which may be according to an established telecommunications protocol, with a cellular base station, such as the cellular base station 50, as shown in FIG. 1. The reader will appreciate that cellular network conditions may change over time, and the particular cellular network base station that a device connects to may change.

The cellular modem 110 may for example be provided by integrated electronics, e.g. a dedicated chip, or a module of a processing chip (e.g. a software and/or hardware module, of a CPU of the security device 100), or by a plug-in modem, e.g. a USB modem or the like. The present disclosure is not limited to any particular telecommunications protocol, but features of LTE and 5G will be discussed in due course. The features may also be applicable to other cellular network, e.g. GSM, 3G. Additionally the device 100 may comprise at least one audio output generator 125 (e.g. one or more speakers) and an audio controller (not shown). One function of such an audio output generator may be to generate a siren to sound an alarm. Optionally, the triggering of an alarm may be accompanied by a strobe light or other light generating device (not shown). The provision of a siren and/or light generator device may be treated herein as a basic deterrent.

An advanced deterrent actuator 130 is operable, on receipt of a control signal, to cause emission of a stronger deterrent than a standard siren and/or light-based deterrent. Optionally the advanced deterrent may only be actuated based on a command derived from human in response to a detected event, For the purpose of this example, the advanced deterrent may for be visible-light obscuring matter. However, as the reader will appreciate, the advanced deterrent can additionally or alternatively include emission of any one or more of tear gas, fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. The advanced deterrent actuator 130 supplied in a particular embodiment will reflect the specific requirements of the implementation. The device may also comprise a deterrent source (not shown), which in some embodiments may be replaceable, and which when actuated by the actuator by the actuator causes release of the deterrent. In a specific example the advanced deterrent actuator comprises an electronic actuator in the form of an electronic switch an electronic switch and the deterrent source comprises a canister which generates and emits light obscuring matter into the surrounding environment when the electronic switch is switched to provide power to the deterrent source. The deterrent source may for example be pyroelectric in nature with the deterrent being smoke, for example.

A controller 140 controls operation of the security device 100, according to a procedure described herein. A microphone 150 and a camera 160 may be provided, to offer facilities to gather information as to the nature of a detected event and to record activity observable at the device 100.

The structure and form of the controller 140 will be implementation specific. In an embodiment, it comprises a central processing unit (CPU) of substantially standard form, and is capable of executing instructions, such as provided in machine code language, to enable performance of its controlling functions. For example, the CPU may comprise one or more microprocessors and/or microcontrollers. Other possible implementations will be recognised by the reader, such as the configuration of an application specific integrated circuit (ASIC) or a field programmable gate array (FPGA), depending on design choices.

The device 100 further comprises a memory 135, that may be comprised of one or more memory devices, one or more of which may be separate from the controller and/or partly or wholly integrated onto a common chip(s) with the chip(s) of the controller. Thus, the controller 140 and/or the memory 135 may be distributed. The memory 135 may store code that, when read by the controller, causes performance of any of the methods described herein, and/or as illustrated in in the drawings. Thus, the memory may be a computer readable medium comprising: volatile memory, for example, one or more dynamic random access (DRAM) modules and/or static random access memory (SRAM) modules; and/or non-volatile memory, for example, one or more read only memory (ROM) modules, which for example may comprise a Flash memory and/or other electrically erasable programmable read-only memory (EEPROM) device. The code may for example be software, firmware, or hardware description language (HDL) or may be any combination of these or any other form of code for one or more processors that is known by a person skilled in the art. Although the controller and memory components may be depicted herein as separate from each other, they may be at least partly integrated into common hardware, e.g. a single chip.

Further, the memory 135 may comprise memory device(s) that may in some embodiments be separate or removable from a unit of the apparatus or system. Such devices may comprise magnetic storage devices (e.g., hard disk, floppy disk, magnetic strips), optical disks (e.g., compact disk (CD), digital versatile disk (DVD)), smart cards, and removable flash memory devices (e.g., card, stick, key drive). Further the memory components may be distributed. For example a distributed server may store code which may be downloaded to the apparatus or system for execution by the at least one processing device described herein, to perform any method described herein that is executable by the at least one processing device. In some embodiments the downloaded code may be stored on local memory of the apparatus or system before execution by the at least one processing device.

A power supply 170 (e.g. one or more batteries) provides power to other components of the device 100. The controller 140 may control distribution of power to other components, for example the cellular modem 110 and/or other high power consumption components such as the microphone 150 and camera 160.

All or some of the above features of the security device 100 may be provided as discrete components or integrated together, depending on the implementation. However, all components of the security device 100 are provided within a single housing.

In the embodiments exemplified herein, the security device 100 is battery powered only, and installed in an installation site as part of a security system at the installation site. However, the present disclosure does not preclude the provision of a mains power supply to embodiments of the security device 100.

The monitoring station 200 provides a human operator interface. This can allow a number of different human monitoring facilities, which may be at a specific site and/or may be distributed. So, for example, on receipt of an event notification, the monitoring station 200 may trigger a human operator to make response decisions as to how the security device 100 should respond. Based on a response decision made by the human operator, and communicated to the monitoring station 200 using human input action, the monitoring station 200 can send an event response signal back to the server 400, which sends a corresponding event response signal back to the security device 100. While the server monitoring station 200 is in the described embodiments remote from the server 400, in other embodiments the functions of the server 400 may be provided by hardware of the monitoring station 200.

The security device 100 can then be responsive to receipt of an event response signal to make a security response action, which may comprise a verification action and/or a deterrent action optionally using the advanced the advanced deterrent actuator 130.

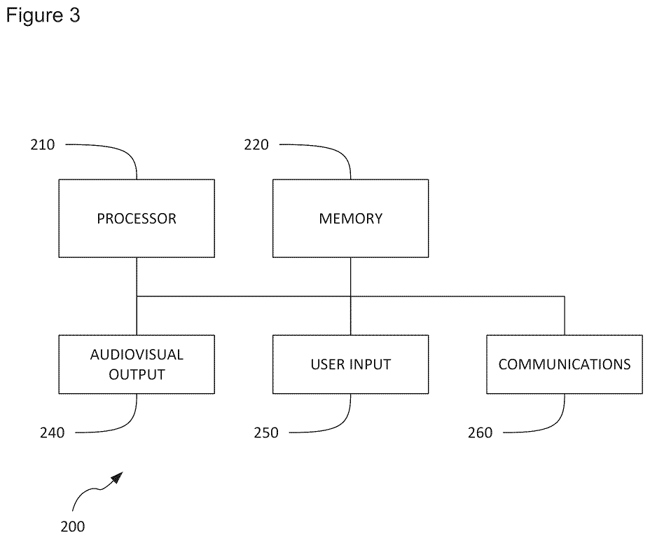

Turning to FIG. 3, the monitoring station 200 may comprise a general purpose computer in conventional form, including a processor 210, a memory 220 comprising one or more elements for short term retention of processing data, and one or more elements for long term (but potentially slow retrieval) storage of program, processing and informational data. In conventional implementations, the processor 210 may comprise a general purpose microprocessor, capable of executing instructions to obtain desired processing functions. The microprocessor may, in certain implementations, be augmented by more application-specific processing capabilities, such as a graphics processing unit (CPU), a System-on-Chip (SoC) suitable for use in establishing communications, or other functions which will be apparent to the reader. The memory 220 may comprise Read Only Memory (ROM) and Random Access Memory (RAM), as required for the provision of memory storage facilities to the processor 210. The storage facilities may comprise a magnetic drive, or a solid-state storage device.

An audio-visual output facility 240 is provided, such as a visual display unit and speakers, for display and audio output to a user, and a user input device 250, such as a keyboard, pointing device (e.g. mouse) and microphone are provided to enable user input action to the monitoring station 200. A communications facility 260 provides connection to the cellular network 30, for instance through internet connection or a direct LTE or 5G protocol modem or to network 35, e.g. via a wired (e.g. Ethernet) or wireless (e.g. WiFi) connection. Optionally the monitoring station 200 may comprise a plurality of such computers, two or more of which may share at least some hardware resources.

For example, a plurality of user input devices and audio/visual outputs may be provided to at a respective plurality of terminals, each attended by an operator.

Any of the above features of the monitoring station 200 may be provided as discrete devices or integrated together. For instance, a laptop or tablet form computer may have more integration of components than a desktop form computer, simply to enable composition of the computer into a constrained form. A desktop form computer offers certain advantages in terms of being able to swap out particular components, such as to upgrade memory facilities, when the need arises.

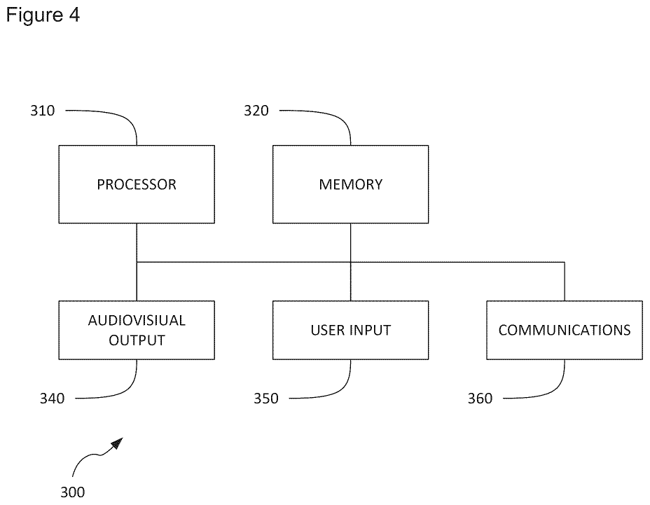

As shown in FIG. 4, the user device 300 comprises a portable computing device, which may be a laptop or tablet, but is generally a handheld device such as smartphone. The user device 300 which includes a processor 310, a memory 320, audio-visual output 340 in the form of a screen and a speaker, user input 350 in the form of a touchscreen and microphone, and a communications unit 360 in the form of an LTE or 5G modem and antenna. The processor 310 and 320 may be comprised of any of the kinds of hardware described above in relation to processor 210 and memory 220 of FIG. 3, but the various components may be integrated if this is the most effective way of achieving a practical device within constraints of form. Optionally the user device 300 may, during use of the system 10, communicate with server 400 using the aforementioned app by first downloading the app from server 400 or from a different server such as an app store (not shown).

The user device 300 may provide an interface to a human operator in addition to or instead of the provision of such an interface by monitoring station 200. Accordingly, the user device 200 may enable a human operator to perform at least the same responses that they may perform at the monitoring station 200 and vice versa.

The server 400 may be configured with functions to enable responsiveness to the event detection notifications by the security device 100 and to various responses to actions performed by the security device 100 and, as the case may be, the monitoring station 200 and the user device 300.

In response to receiving an event notification from the security device 100, the server 400 can provide the security device 100 with further commands and/or information, optionally based on input by the monitoring station 200 or user device 300, to enable the security device 100 to perform an appropriate response to the detected event. Since human derived commands for security device 100 may be generated at the monitoring station 200 and/or user device 300, the monitoring station 200 and/or user device 300 may be referred to herein as an operator node or operator device.

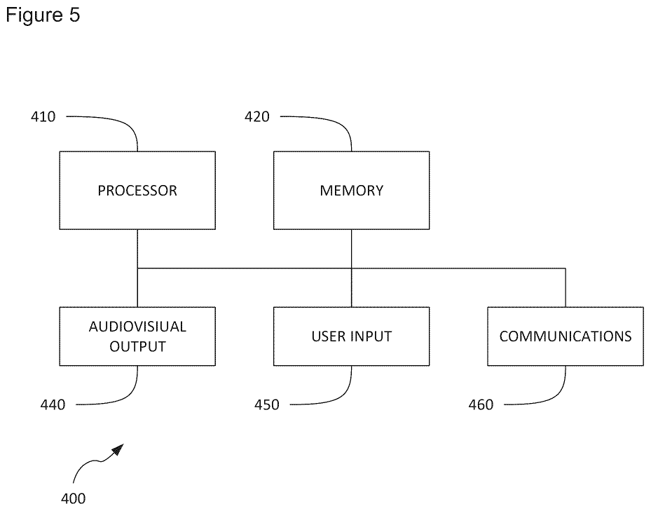

The server 400, as shown in FIG. 5, comprises a computing device which includes a processor 410, a memory 420, and a communications unit 460 in the form of a modem for establishment of a connection with the cellular network 30 and optionally a different modem to establish a connection to network 35. The processor 410 and 420 may be comprised of any of the kinds of hardware described above in relation to processor and memory of FIG. 3. Optionally the server may also comprise an audio-visual output 440 in the form of a screen, user input 450 in the form of a keyboard and pointing device. The server 400 provides an interface between the monitoring station 200 and the user device 300, and the security device 100. As will be appreciated the server 400 may optionally be a distributed system and/or may be “cloud” implemented based. As already mentioned, the server 400 may comprise one or more application servers for the various clients, i.e. for the security device 100, and for the monitoring station and/or user device 300. In some embodiments, each of the clients may connect to the application server directly (e.g. using a UDP connection) or through a broker, e.g. as web server (e.g. HTTP or HTTPS) or an MQTT broker. However, in examples described herein, the application server may be assumed to use an MQTT broker at least for communications with the security device 100. When referring herein communicating to or from the server 400, this may include communicating to or from any such broker.

In the present disclosure, the server 400 stores in its memory 420 a record of a current arming state for the security device 100 requested by an operator device, which may be the monitoring station 200 or the user device 200, but may be taken the examples which follow as being, more specifically, the user device 200. This is because the user device 300 is intended for use by an owner, resident or other invested person (e.g. a business owner or employee) of the premises at which the security device 100 is installed, whereas the monitoring station is intended to be staffed by professional operators dedicated to the task of monitoring multiple premises.

Configuration of the armed/unarmed state, and other operational parameters, may be made by human input action at an application (an “app”) hosted on the user device 300. As the user device 300 has cellular connection capability, a user can operate a user device 300 to put the security device 10 into the armed state, regardless of the user's physical location.

The arming state may be an “armed” state for configuring the security device to carry out an event response action (also referred to herein as a “security response action”, “response action” or an event response), or may be an “unarmed” state for not carrying out such an action. The arming state of the security device may be specific to that security device or may be of the security system as a whole, or to a part thereof, to also be applicable to other devices in the system 10.

Optionally the system 10 may include multiple devices for a given premises relevant to the user, and so system 10 may have a hybrid states of armed states and unarmed states for the premises. For instance, in a multi-zone installation, different zones may be armed while other zones remain unarmed. This is useful for example if, in a residential dwelling, it is intended to allow occupants to retire to sleeping quarters while securing other parts of the dwelling. The singular device 100, however, may more specifically be intended to be in either an armed or disarmed state.

The security device 100, too, stores a copy of the operator requested arming state in its local memory 135 (which may also be referred to herein as a “local copy”). However, as will be described, there is a lag in updating the operator requested arming state record on the device 100 because, to save power, the device 100 is not always available for communication, leading to a potentially substantial asynchrony. In particular the modem 110 of the device 100 may operate in a sleep mode or off mode for maximum period of, for example, 30 seconds or more. A maximum interval between successive times at which the modem 110 is able to receive cellular communication may be no less than the maximum period of the sleep or off mode. As has been described, the security device 100 communicates with the server 400 using a cellular modem 110, which advantageously obviates the need for a locally installed control hub. Communicating over a cellular link consumes substantially more power than is generally required to communicate with a local hub. However, the security device 100 is operable in a first mode for conserving power consumed by the cellular modem 110 when the device 100 does not need to transmit. However, in the first mode the device 100 may occasionally receive cellular signals, which enables the device 100 to periodically obtain updates regarding certain configuration (e.g. pertaining to the current operator requested arming state set for the device 100).

The manner in which the modem 110 is periodically able to receive cellular signals may be such that the first mode provides a maximum latency in communicating to the security device that may be too slow for when a user may want to command the device to perform an urgent action, e.g. to verify the threat is real and/or needing to be dealt with, or to emit a deterrent in response to a detected event. For example, where the maximum period of the sleep or off mode is 30 seconds, there may be a latency that is at least this long. In other embodiments the maximum period of the sleep or off mode is even longer. However, the device 100 may initiate a change by which it switches to a second mode with a shorter maximum sleep or off period, e.g. in the order of 10 seconds or less, when a response to a detected event may be needed. The device 100 operates in the second mode that is maintained for a waiting period, the waiting period being provided to enable an operator to provide a response to an event detected by the device 100. In various embodiments, as a further means of saving power the device 100 only operates in the second mode in response to a detected event, if there is satisfaction of a condition comprising that an event is detected by the sensor while an arming state on the device 100 is set to armed.

In some embodiments, power may be saved by not switching to the second mode for the waiting period if the condition is not met. In some embodiments, a notification of a detected event may be transmitted regardless of whether the condition is met, but in other embodiments further power may be saved by only transmitting the notification of the event if the condition is met. In some embodiments the transmitting of the notification may serve as a prompt for the server to check whether an arming state setting for the device 100 as stored on the server 400 (but potentially not yet delivered to the device) is set to armed and/or to reply to the device with a response by which the device 100 is to verify that the device's locally stored arming state record is consistent with the current arming state as stored on the server 400. It will be appreciated that any arming state identifier that may be received by the device 100 to enable the device 100 to verify that the current arming state record on the device matches any remotely stored current arming states may explicitly define the arming state, or may define that there has been a change in the arming state. However, that arming state identifier transmitted from the server 400 to the device 100 may alternatively imply the arming state, for example by defining an instruction for the device 100, the provision of which is dependent upon the remotely stored arming state (e.g. an instruction to sound a siren would imply an armed arming state).

The transmitting of the notification may be when the device 100 is in the second mode, but in other embodiments the transmitting of the notification may be before the device 100 enters the second mode. Further, in some embodiments the user is notified not only of the detected event but also of an indication of a time remaining to communicate with the security device 100 before it returns to the first state, since the first state may result in a longer latency. Optionally the user has the capacity to issue a command to the security device 100 that extends the waiting period thereby providing a longer time for the user to response using the shorter latency.

Further, in some embodiments, in the first mode of operation the device 100 may receive cellular communications at specific times coordinated with the cellular network by which it is agreed between the modem 110 and the cellular network 30 when the modem 110 is to be in a receptive state. In this manner the modem 110 can receive updates as to its arming state without having to poll the server 400. Likewise, once the device 100 has transmitted a notification of the detected event and transitioned to the second mode and, the modem 110 may receive commands for responding to the detected event, via the cellular network during the waiting period, without having to poll the server 400, in some embodiments.

An example manner in which this may be achieved is now described with reference to an example of paging within the context of the present disclosure. In some embodiments the device 100 operates in at least the first mode with the modem being in an idle condition in which the modem 110 is mostly asleep but at certain times that are scheduled to be synchronized with the server 400, the modem 110 listens for a paging communication from the cellular network 30. In order to receive messages from the server or send messages to the server 400 the modem 110 needs to leave the idle mode and switch to a connected mode, which may be a Radio Resource Control (RRC) connected mode.

When the server 400 tries to send a communication to the device 100, the cellular core network 20 then transmits a paging signal to the device 100 when the device's modem 110 is listening. In response to receiving the paging signal the modem 110 initiates a random access procedure with the cellular network 30 that places the modem 110 into a Radio Resource Control (RRC) connected mode. The device 100 may then receive the communication.

As will be appreciated from the depicted examples, in some embodiments the server 400 pushes arming state updates to the device 100, resulting in the cellular network 30 paging the device 100. For such embodiments, the device 100 transmits periodic keep-alive signals. The keep alive signals may be transmitted with a regularity sufficient to maintain a connection to a MQTT broker used by the server 400 (e.g. to maintain a subscription to an MQTT topic), with the regularity being greater then maximum time interval referred to herein. It may for example be at least 5 times greater, or at least 10 times greater.

In some embodiments, the device 100 switching between the first and second modes comprises the modem 110 detaching and reattaching from the cellular core network 20 to request the feature of the correspond one of the first and second modes. However, in any case, at least for the duration of the device 100 being in the first mode the modem 110 may optionally maintain attachment to the cellular network 30. By keeping attached, there is no need to re-attach or re-establish PDN connections each time the device 100 needs to communicate using the WAN 35. Likewise, the duration of the device 100 being in the second mode the modem 110 may maintain attachment to the cellular network 30.

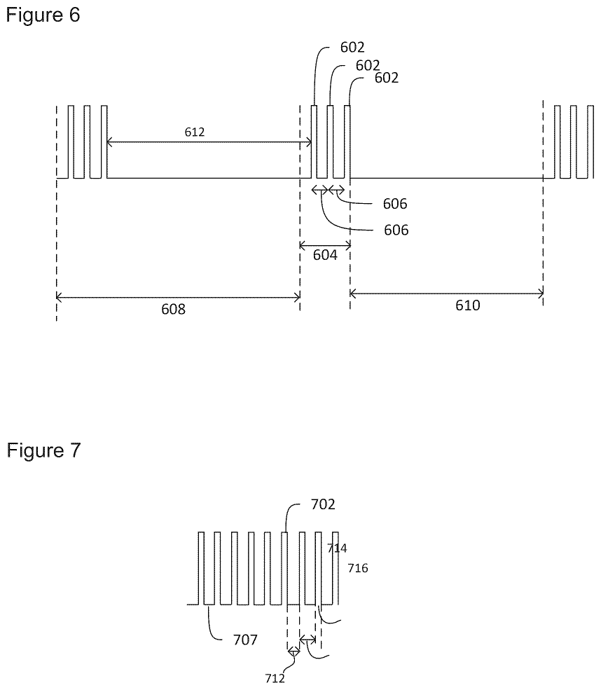

FIG. 6 illustrates a conceptual diagram showing times depicting current consumption by the cellular modem 110 of the security device 100, according to an example, when the security device 100 is in the first mode of operation. Using this mode, the device 100 is able to periodically receive an arming state identifier to synchronize the device arming state with that stored on the server 400. This may be achieved by the cellular core network 20 paging the device 100 during one of a plurality of periodically spaced times 602 at which the modem 110 is in listening state (as opposed to being asleep, for example). In response to being paged the modem 110 switches the device 100 out of the first mode by the modem 110 initiating a random access procedure with the cellular network that places the modem 110 into a Radio Resource Control (RRC) state (not shown in FIG. 6). The modem 110 may then receive the arming state identifier.

The listening times 602 alternative with non-listening times during a paging phase having a duration 604 of a repeating cycle having a period 608. During the non-listening times the modem 110 may be in a sleep state. Within in the paging phase the listening times occur according to a cycle within the paging phase, the cycle within the paging phase having a periodicity, as indicated by 606. The listening times constitute paging opportunities. Between successive paging phases the modem is in an extended sleep phase having a duration 610, in which the modem does not listen for signals and therefore may be in a sleep state, which may be a deep sleep state. The extended sleep phase may be considered extended in the sense of being longer than any of the sleep states during the paging phase. During the cycle within the paging phase, when the modem 110 is not in a listening state it may be in a sleep state, but for a duration that is less the duration of the extended sleep phase.

In the illustrated example, when the cycle within the paging phase commences the modem is depicted as being in a sleep state, but it may alternatively commence with the modem starting in the listening state. In the first mode there is a first maximum interval 612 between successive times at which the modem is able to receive cellular communications, the first maximum interval including the extended sleep phase. Optionally the period 608 of the repeating cycle of the first mode has a value in the range of 20 to 170 seconds, but in another embodiment in a range of 20 to 90 seconds, and in other embodiment in a range between 40 and 90 seconds, for example 40.96 or 81.92 seconds. Optionally the duration of the paging phase may be set to a value that is no more than one quarter of the period of the cycle (i.e. no more than 10.24 seconds for a cycle of 40.96 seconds and no more than 20.48 seconds for a cycle of 81.92 seconds).

In some embodiments, the modem 110 sets up for operating with the cellular network 30 to suit the respective first and/or second modes by requesting a feature of the cellular communications protocol when attaching to the cellular network 30. For example in the context of LTE or 5G or other cellular protocols (e.g. GSM, 3G), for the first mode, this may comprise requesting values used by the cellular network 30 to enable extended discontinuous reception (eDRX), for example values for the TeDRX Timer the Paging Time Window Time (PTW).

In the examples herein the operation of the modem 110 when the device 100 is in the first mode may be eDRX operation in accordance with a standard of the 3^{rd} Generation Partnership Project (3GPP), for example Cat NB1, Cat NB2 or Cat M1 or Cat M2, for example in accordance LTE or 5G. In some implementations, more specifically, in accordance with 3GPP release 13, which covers LTE Cat M1 and LTE NB1 and in other implementations, in accordance with LTE Cat M1 and 3GPP release 14, which covers LTE Cat NB2 and LTE Cat M2.

The period 608 may be set by a TeDRX timer, and the period 604 may be a period of a Paging Transmission Window Time (PTW). The periodicity 606 of cycle within the paging phase may be the duration of a regular (i.e. non-extended) DRX cycle.

To operate using eDRX in coordination with the cellular network, the modem requests values for TeDRX and PTW when attaching to the cellular network (it may alternatively be requested when performing a tracking area update (TAU), but a TAU can only be performed at times that are prescheduled with the cellular network). When the device 100 no longer needs to be in the second mode it may, in some embodiments, detach from the cellular network 30 and then reattach to operate again in the second mode.

FIG. 7 illustrates a conceptual diagram showing times depicting current consumption by a cellular modem 110 of device 100, according to an example, when the security device 100 in the second mode of operation. In the second mode of operation, there are listening periods 707 in which the modem 110 is able to receive communication an non listening periods in which the modem 110 is not able to receive communications and is in a sleep mode. The time interval between the start of successive listening periods is constant and the duration of each listening period being constant. This characteristic is shared by the paging phase described above in reference to FIG. 6.

However, in the second mode, since there is no extended sleep phase as there is in the first mode. In this example, the maximum interval 712 between successive times at which the modem 110 is able to receive cellular communications is equal to the difference between the time interval 714 between the start of successive listening periods and the duration 716 of each listening period. Further this, maximum time interval is shorter than the first maximum time interval referred to above.

In some embodiments, to operate in the second mode a different feature(s) of the cellular network 30 may be utilized to a feature used for the first mode. This may be achieved, for example by requesting a value for the T3324 Active Timer (hereinafter simply referred to as T3324) for Power Saving Mode as will be described in more detail below, or by operating in discontinuous reception (DRX). In some embodiments, this may more particularly comprise operating in idle mode discontinuous reception (i.e. idle mode DRX), though in some embodiments connected discontinuous reception (Connected DRX) may be utilised in the second mode.

It will be appreciated by the person skilled in the art the eDRX occurs when the modem is idle (as opposed to connected) mode. However for avoidance of confusion, when using the term “DRX” herein without reference to the term “extended” it is intended to refer to a form of discontinuous reception other than eDRX.

When DRX used in the second mode the cellular modem 110 is intermittently in a reception state, i.e. in a listening period, within listening periods spaced by non-listening (optionally sleep) periods. For the listening periods may for example repeat with a periodicity in the range of 0.64 to 5.12 seconds, so as to avoid excessive power consumption, albeit without having an extended sleep phase in the second mode. In a more specific example, the second mode may comprise DRX mode consisting of listening for 40 ms of a repeating period lasting 2.56 seconds.

The second mode as exemplified in FIG. 7 may involve the modem 110 operating in DRX in accordance with either of the 3GPP standards referred to above, for example being idle mode DRX. To operate the idle mode DRX feature in coordination with the cellular network 30, the modem 110 performs an attachment procedure with the cellular network 30 in which the modem 110 does not ask for eDRX values (i.e. it does not ask for TeDRX or PTW) or for any other power saving feature (e.g. PSM). When the device 100 no longer needs to be in the second mode it may, in some embodiments, detach from the cellular network 30 and then reattach to the cellular network 30 to set up operation again in the first mode.

Although not illustrated in FIG. 7 it is possible that while the device 100 is in the second mode, the device 100 may transmit information, for or receive information from, the server 400. However for idle mode DRX, like in the case of eDRX, this requires the modem 110 to firstly transition to an RRC connected mode. That is, to transmit information for the server 400, the modem 110 must first initiate an exchange with the cellular core network 20 that places the modem 110 in an RRC connected mode. To receive information from the server 400 the modem 110 must be paged by the cellular core network 20 during a listening phase and in response the device 100 must initiate an exchange with the cellular core network 20 that places the modem 110 in an RRC connected mode.

In other embodiments, during some or all of the second mode the modem 110 may have continuous reception. The continuous reception may be provided in an RRC (radio resource control) connected mode.

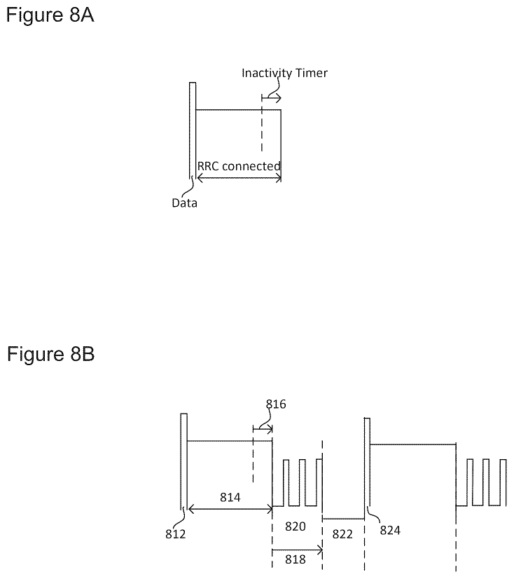

To explain how the second mode may be generated using an RRC connected mode, it is first worthwhile describing certain features of the RRC connected mode, with reference to FIG. 8A. When in the RRC connected mode the cellular network 30 commences an Inactivity Timer. If there is no traffic to or from the security device 100 for a period of timer longer that a value used by the Inactivity Timer, the cellular network 30 releases the security device 100 from RRC connected mode to enter RRC idle mode. Optionally, the modem 110 may maintain the device 100 in the RRC connected mode by continuing to transmit before the value used by the Inactivity Timer is reached.

For the device 100 to maintain itself in the second mode for the waiting period the device 100 may continuously transmit with a period between transmissions that is less than the value used by the Inactivity Timer (thereby restarting the Inactivity Timer). When the waiting period has expired device, the device 100 may cease the continuous transmissions to allow the device 100 to return to the RRC idle mode.

If upon attaching to the cellular network 30, the modem 110 was configured for extended DRX, then when the device 100 is released from the RRC connected mode it will return to operate extended DRX, thereby returning to the first mode.

In other embodiments, the continuous reception is provided for only some of the waiting period. For example, while in the RRC connected mode the modem 110 may operate DRX, like was described above in relation to FIG. 7, but being Connected DRX.

A further example may utilize the Power Saving Mode (PSM) feature of the abovementioned 3GPP standards. A specific example is now described with reference to FIG. 8B. Use of the PSM feature may be achieved by requesting a value for T3324 when attaching to the cellular network 30 (though such a value may alternatively be requested when performing a Tacking Area Update). Optionally when requesting a value for the T3324 timer a value for a T3412 timer may be requested to set a specific time interval for performing a Tracking Area Update. However, in the example of FIG. 8B the value that would typically be set for the Tracking Area Updates would be so large so as not to come in the second mode of operation (e.g. it would be larger than the duration operating in the second mode).

Using PSM, the modem 110 is in a sleep phase/state (e.g. a deep sleep state) until the device 100 initiates connection to the cellular network 30. The initiation involves a transfer of data, as indicated at 812. This places the modem 110 into RRC connected mode for a duration of time 814. While in RRC connected mode, the cellular core network 20 operates an Inactivity Timer 816. If there is traffic to or from the security device 100 for a period of time longer that a value used by the Inactivity Timer, the cellular network 30 releases the security device 100 from RRC connected mode to enter RRC idle mode.

In this version of providing the second mode, in order to save power, rather than keeping the modem 110 in the RRC connected mode by continuously transmitting, the modem 110 allows the Inactivity Timer to expire thereby releasing the modem 110 into the RRC idle mode. This commences the T3324 timer 818, and until the timer T3324 timer expires (when it reaches the requested value) the modem 110 operates in idle mode DRX 820. At the expiry of the T3324 818 idle mode DRX 820 finishes and the modem 110 enters a deep sleep 822 until the modem 110 is next commanded by the device 100 to enter the RRC connected mode at 824.

In some embodiments the waiting period may be provided based on the value selected for the T3324. For example the waiting period may end when T3324 expires. In other embodiments, however, the waiting period may be controlled to a higher resolution by using a shorter value for T3324 then transmitting another signal, thereby involving the modem 110 re-entering the RRC connected state and repeating the cycle just described. This may be repeated as many times as needed to provide the desired duration of the waiting period. Optionally the re-entering to the RRC connected mode may be the TT324 timer is operating or, as illustrated in the figure, shortly after the expiry of the TT324, so long as the maximum interval between successive listening periods permitted for the second mode is adhered to.

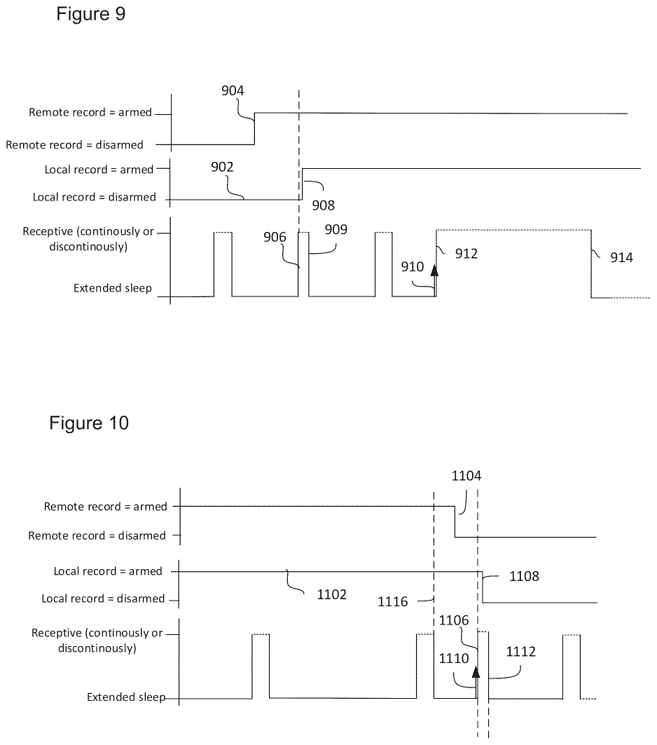

FIGS. 9 to 10 depict various examples of operation commencing with the device 100 being in the first mode of operation. In each of these examples, the device is depicted as either being in an extended sleep phase or not being in an extended sleep phase. It will be appreciated this example is depicted with reference to the first mode comprising a paging phase and a sleep phase as described herein, but the same concepts may be applied to other manners of providing the first mode of operation. For the purposes of the examples described in FIGS. 9 and 10, the other state during the first mode may be assumed to be a paging phase, i.e. in the first mode the modem is in eDRX. However, optionally first mode may be provided in other manners.

FIG. 9 illustrates an example a scenario causing the security device 100 to switch from the first mode to the second mode. In this example, the device 100 is initially, at time 902, unarmed. At 904 the user device 300 receives a command from a user to enter the device 100 into an armed state, and this command is conveyed to the server 400 for forwarding to the security device 100. The command is ready for transmission to the security device 100 shortly thereafter (though for the purpose of this explanation may be treated also as being at 904). The sever 400 indicates to the cellular network 30 that it wants to communicate with the device 100. When the extended sleep phase ends at 906, the modem of the device 100 switches to a receptive state during which time the cellular core network 20 pages the device 100. In response, the device initiates a random access procedure with the cellular network 30 to enter an RRC connected state and the modem then receives the updated armed state. The device 100 then returns to an extended sleep at 909.

At 910 the device 100 detects an event, and since the local arming state record indicates the device 100 is armed, the device 100 switches from the first mode to the second mode at 912 for a duration defined by a waiting period. During the waiting period, due the relatively shorter maximum between listening periods (compared with the first most) commands can be communicated to the device 100 with a short latency. At the expiry of the waiting period, at 914, the device 100 may return to the first mode.

In this example, the device 100 may determine to operate in the second mode only on the basis that the arming state stored on the device 100 at the time of the event detection was an armed state.

However, in another embodiment, the device 100 may first verify that with the server 400 that the arming state stored on the device 100 is consistent with an arming state stored on the server 400 before determining to commence the waiting period (i.e. commence the second mode of operation of the device). If the verification fails (i.e. the arming state on the server 400 is a disarmed state) the device 100 returns to the first mode without commencing the second mode. As will be appreciated at least from this example, the commencement of the waiting period need not necessarily require the modem 110 to change its state from the state it has been in during the communications mode. However, in some embodiments there is a distinct change in the modem 110 configuration, e.g. by utilizing a different feature or mode of the cellular network 30, which for the modem 110 to access may require detaching and reattaching to the cellular network 30. Further, in the absence of the modem 110 transmitting verification data during the waiting period, the modem 110 may in some embodiments not transmit any data or transmit so little data as to consume less power while in the waiting period compared to when in the communications mode before commencing the waiting period.

FIG. 10 illustrates another example of a scenario causing the security device 100 to switch from the first mode to another mode in which the modem 110 is in a communications mode but immediately thereafter switch back to the first mode, in an embodiment. In this example, the device 100 is initially, at time 1102, armed. At 1104 the user device 300 receives a command from a user to disarm the device 100, and this command is conveyed to the server 400 for forwarding (optionally via an MQTT broker) to the security device 100. The command is ready for transmission to the security device 100 shortly thereafter (though for the purpose of this explanation may be treated also as being at 1104). However, the security device 100 cannot receive any commands because it is asleep, and is still asleep when an event is detected at 1110. Since the arming state stored on the device 100 is armed when the event is detected, at 1106 the device 100 immediately leaves the first mode by prematurely ending the sleep period and enters another mode in which the modem 110 switches to RRC connected mode and communicates with the server 400. The device 100 then at 1108, receives a signal informing it that the device 100 had been remotely set to be switched to an unarmed state. Based on a timestamp associated with that received signal, that the remote setting to the unarmed state had occurred before the event had been detected. As a result, the device 100 determines that is not required to be commence a waiting period and so immediately switches back to the first mode at 1112. In an embodiment the signal informing it that the device 100 had been remotely set to be switched to an unarmed state is received in response to the device 100 transmitting a notification of the event. However, in another embodiment the signal may be received prior to transmitting such a notification, in which case the device 100 may in some embodiments not send the notification.

It will be appreciated that user device 300, and the security device 100, received the disarm command earlier, so that the device 100 disarmed before the commencement at 1116 of the extended sleep phase during which the event was detected, then the device 100 would not have switched to out of the first mode in response to the detected event.

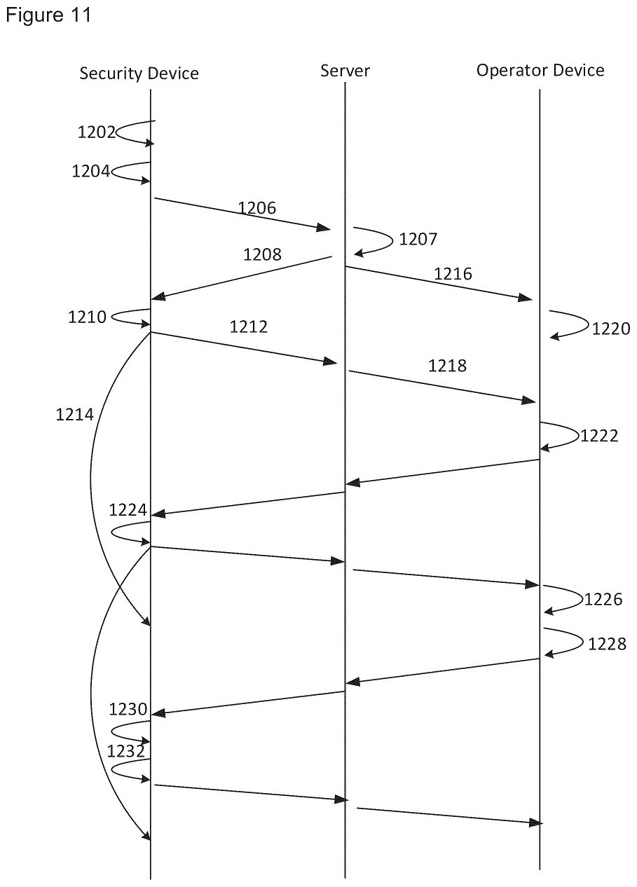

FIG. 11 illustrates a swim-lane diagram for an example operation of the security device 100 and system 10 containing the security device 100 in a situation in which the security device 100 is armed before an event is detected.

The example commences with the device 100 detecting an event at step 1202. In response, at 1204, the device 100 may capture one or more images (e.g. a photo or a video) and switches to another mode that may then be used the device 100 at 1206 to notify the server 400 of the detected event and obtain a response to the notification. At 1207 the server 400 may verify that notification constitutes a valid threat detection (e. g based on the arming state as set at the server 400). At 1208 the server 400 may check consistency between its arming state and that of the device 100 and transmit a signal to the device 100 that confirms the consistency.

At 1210 in response to having the armed state confirmed the device 100 may optionally sound an alarm siren, or start a count-down timer upon the expiry of which the device 100 will sound an alarm if it does not in the meantime receive a user command instruction that cancels the alarm. In a variation of this example such a countdown timer may be commenced at step 1204 and may additionally be cancelled if necessary depending on the reply from the server 400 at step 1208.

Additionally or alternatively in response to having the arming state confirmed the device 100 may in some embodiments transmit the image(s) it had captured at step 1204 and/or may capture one or more further images (and optionally transmit it/them), the transmitting of images being at step 1212.

Then at step 1214 the device 100 the switches to the second mode whereby it maintains a short latency connection with the cellular network 30 for a duration defined by a waiting period. In other embodiments this step may occur at 1210, i.e. upon having the arming state confirmed as being armed. In embodiments in which no verification of the arming state is performed, the switching to the second mode may optionally occur when transmitting the notification of the event.

Regardless of when the waiting period is commenced, for embodiments herein which the device 100 does verify consistency with regard to its arming state, the length of time with the device 100 is not operating in the first mode is longer in the event that there is an arming state consistency compared with there being arming state inconsistency. For example, if the device 100 learns that it had not most recently been intended by the user to be in the armed state, the device 100 responds by returning to the first mode at that time rather delaying the returning to provide an opportunity for a user response.

Upon receiving the notification of the event and optionally conditionally upon confirming with the notification represents a valid threat detection event (e.g. based on arming state information stored at the server), the server 400 transmits an alert to an operator device 300 at step 1216. In some embodiments, the server 400 also transmits to the operator device 300 any images (or sound) received from step 1212.

At 1220 the operator device 300 receives the alert from the server 400 and indicates the alert to the user of the operator device 300, e.g. using a sound notification and a pop-up notification on a screen. Additionally the operator device 300 displays an indication of a remaining time (e.g. as a countdown time) for contacting the security device 100 in order to ensure that any commands from the operator device 300 reach the security device 100 before the waiting window expires. To provide a safety margin the indicated time may be before the scheduled end of the waiting period. For example, a countdown display may display a time which may include a reduction to compensate for user reaction time and system latency, to encourage a user to make an early decision, so that the user's decision can be conveyed to the security device 100 in due time.

Optionally the user may then use the operator device 300 to perform any of the following actions:
a) view any received images (or sounds) that have captured by the security device 100;
b) dismiss the event;
c) disarm the device 100; or
d) command the device 100 to perform a response action, optionally from a range of response actions.
e) extend the response window

The range of response actions may include one or more verification actions and deterrent actions (e.g. actions for outputting an advanced deterrent). In an embodiment, the available response action includes emitted light-obscuring matter.

If the user selects options b) or c) the device 100 upon receiving the selection (which generally will be received via the server) may end the waiting period.

If the user selects options e) the device 100 upon receiving the selection extends the waiting period. This will also result in an indication, to the user, of an updated remaining time for contacting the security device 100 in order to ensure that any commands from the operator device 300 reach the security device 100 before the waiting window expires.

However, in this example it is assumed that at step 1222 the user selects option d) optionally after first selecting option a). The response action selected in this example is a verification action (e.g. capturing one or more further images).

The device 100 then receives the selection as 1224, and in response performs the response action. In some embodiments, as illustrated in FIG. 11, this also results in the device 100 extending the waiting period. At step 1226 the operator device 300 receives at least some evidence of the verification, e.g. the captured images or an indication that the images are available from the server 400 for downloading, enabling the user to observe the evidence.

At 1228 the user may provide a further response action. For example the user may present with the same options as presented at step 1222. In this illustrative example the user selects a deterrent action, which comprises emitted light-obscuring matter, in an embodiment.

The device 100 receives and then performs the commanded deterrent action at 1230, and in some embodiments then performs a verification action to confirm that present an indication of the observed scene after performing the deterrent action (e.g. captures more images) and optionally transmits evidence of the verification for eventual delivery to the operator device 300. Thereafter, in some embodiments the device 100 will again extend the waiting period, e.g. in case the user wants further verifications, and in other embodiments, the device 100 will instead immediately end the waiting period, and in yet other embodiments the device 100 will allow the waiting period to expire when it had been scheduled to expire.

As used herein, except where the context requires otherwise, the terms “comprises”, “includes”, “has”, and grammatical variants of these terms, are not intended to be exhaustive. They are intended to allow for the possibility of further additives, components, integers or steps.

It should be noted that while embodiments are described that do not include a control hub local to the secured premises, the present disclosure does not preclude provision of a control hub.

As will be appreciated by a person skilled in the art, the listening periods referred to herein are synchronized with the cellular core network 20 so that the cellular core network 20 knows when it can send messages to the device 100.

The embodiments described above are intended to be indicative, and are not limiting on the scope of protection sought, which should be determined on the basis of the claims appended hereto.

The cellular communications herein may be LTE and/or 5G compliant, for example in accordance with CAT M1, CAT M2, CAT NB1 or CAT NB2 parts of the LTE protocol, in some embodiments.

Any embodiments herein in relation to a device or system is also applicable to a method and to a computer program product, which may take the form of a processor executable non-transient memory for storing instructions which when executed by the processor cause the performance of the method. Alternative implementations of a computer program product are contemplated as part of the present disclosure, including that such a product may be delivered by way of a downloaded signal from a server, and may be in the form of an update or cooperative product to one or more computer program products already installed in the device.

In the examples of the first mode provided above in relation to FIGS. 6, 9 and 10, the arming state may be updated using push notifications. However in alternative example of a first mode of operation in accordance with one or more embodiments, the device 100 may use the PSM mode feature of the cellular network 30. For example, the device 100 may operate in a PSM and with a periodicity selected to define first maximum time interval wake to poll the server 400 to obtain the most current arming state information.

Like in the cases of 6, 9 and 10, apart from finding out the most current arming state information the device 100 may while monitoring for a detected event remain in a deep sleep in accordance with by the PSM mode (or in an alternative embodiment may be off) while monitoring for an event.

Like in the case of 6, 9 and 10, if an event being monitored for is detected while the modem 110 of the device 100 is in the sleep phase between being able to obtain arming state updates, and the device 100 is armed, the modem 110 wakes early from the sleep mode (i.e. before it would have woken for the next listening time) and the device 100 notifies the server 400 using the modem 110. In this example the device 100 may provide the second mode of operation, and also the first mode of operation, by performing a procedure in accordance with FIG. 8B, with a short (e.g. no more than 5.12 seconds) or zero-length duration 822 of being in deep sleep. In such an embodiment the device 100 may maintain attachment to the cellular core network 20 so that it does not need to reattach to the cellular core network 20 when switching from the first mode of operation to the second mode of operation nor when switching back to the first mode of operation.

The following clauses represent at least some aspects and embodiments of the present disclosure:
1. a Security Device Comprising:
   a cellular modem for establishing a communications channel between the device and a base station of a cellular network; and
   a sensor for detecting an event within a monitored environment;
   wherein the device is operable in a first mode in which there is a first maximum interval between successive times at which the modem is able to receive cellular communications;
   wherein in response to satisfaction of a condition, the device operates in a second mode in which the modem is continuously able to receive cellular communications or in which there is a second maximum interval between successive times at which the modem is able to receive cellular communications, wherein the second maximum time is shorter than the first maximum time interval, and the device remains in second mode for a waiting period to enable receipt of an operator command via the cellular modem, wherein the condition comprises that an operator requested arming state for the device that is stored on the device when the event is detected by the sensor is an armed state.
2. A security device comprising:
   a cellular modem for establishing a communications channel between the device and a base station of a cellular network;
   a sensor for detecting an event within a monitored environment; and
   a memory for storing an operator requested arming state;
   wherein the device is operable in a first mode in which the operator requested arming state is updatable via the cellular modem with a regularity that is limited by a first maximum time interval;
   wherein in response to satisfaction of a condition, the device operates in a second mode in which the modem is continuously able to receive cellular communications or in which there is a second maximum interval between successive times at which the modem is able to receive cellular communications, wherein the second maximum time is shorter than the first maximum time interval, and the device remains in second mode for a waiting period to enable receipt of an operator command via the cellular modem,
   wherein the condition comprises that an operator requested arming state for the device that is stored on the device when the event is detected by the sensor is an armed state.
3. A device according to clause 1 or 2 wherein, in response to the operator requested arming state for the device that is stored on the device when the event is detected by the sensor being an armed state, the device modem operates in a communications mode to determine whether the arming state for the device that is stored on the device is consistent with a remotely set arming state that had not been stored on the device when the event was detected by the sensor is an armed state, wherein the condition further comprises that the arming state for the device that is stored on the device is consistent with a remotely set arming state that had not been stored on the device when the event was detected by the sensor is an armed state.
4. A device according to any one of clauses 1 to 3, wherein the operator requested arming state for the device is based on a communication received via the cellular modem.
5. A device according to clause 4, wherein the communication was received following a paging communication to the device from the cellular network, wherein the paging communication was received by the device while the device operated in the first mode.
6. A device according to any one of the clauses 3 to 5, wherein operation of the sensor is at least partly dependent on the operator requested arming state for the device that is stored on the device.
7. A device according to any one of the clauses 3 to 5, wherein, the sensor is operational regardless of the operator requested arming state for the device that is stored on the device.
8. A device according to any one of the preceding clauses wherein the first maximum time interval comprises a power conserving period in which the modem is in an off or sleep state and the second maximum time is shorter the power conserving period.
9. A device according to clause 8, wherein in response to detecting the event during the power conserving period, the device ends operating in the first mode before an expiry of the power conserving period to enter the modem into a communications mode to at least one of:
   determine whether the arming state for the device that is stored on the device is consistent with a remotely set arming state that had not been stored on the device when the event was detected by the sensor is an armed state; and
   transmit a notification of the detected event.
10. The device according to any one of the preceding clauses, wherein the first maximum time interval comprises a power conserving period in which the modem is in an off or sleep state and the second maximum time is shorter the power conserving period, wherein the device is configured to obtain updates to the arming state without interrupting the power conserving period. In an embodiment obtaining an update to the arming state without interrupting the power conserving period comprises receiving a push notification, the receiving of the push notification comprising receiving a signal from the cellular network when the modem is able to receive cellular communications in the first mode. In another embodiment, obtaining updates to the arming state without interrupting the power conserving period comprises polling a server, wherein the times at which the modem is able to receive cellular communications follow communication windows opened by the device after respective ones of the power conserving periods. In some embodiments, each communication window is commenced by a transmission from the modem. In an example, this may be achieved by operating the device using a PSM feature of the cellular network, wherein the modem transitions to an RRC connected state in order to commence the communication window. In an embodiment, each time a communication window the device engages in a tracking area update procedure and/or transmits a keep-alive message and/or transmits a signal for a remote server to supervise a health of the security device.
11. A device according to any one of the preceding clauses wherein the first maximum time window is no less than 20 seconds, e.g. no less than 30 seconds.
12. A device according to any one of the preceding clauses wherein the first maximum time window is no more than 164 seconds, e.g. no more than 80 seconds.
13. A device according to any one of the preceding clauses wherein the second maximum time window is no more than 6 seconds.
14. A device according to any one of the preceding clauses wherein said cellular communications are received by the modem in accordance with 3GPP release 13 in relation to Cat M1 or Cat NB1.
15. A device according to any one of clauses 1 to 13 wherein said cellular communications are received by the modem in accordance with 3GPP release 14 in relation to Cat M2 or Cat NB2.
16. A device according to any one of the preceding clauses wherein when the device is in the first mode the modem operates a cycle comprising an extended sleep phase and a paging phase.
17. A device according to clause 16 wherein during the extended sleep phase the modem is in a condition in which it is unable to receive cellular communications, e.g. it may be in a sleep state (e.g. a deep sleep state).
18. A device according to clause 16 or 17, wherein when the device is in the first mode the modem is able to receive cellular communications only during a paging opportunity of a plurality of predetermined paging opportunities in the paging phase.
19. A device according to clause 18, wherein while in the paging phase the modem operates in a sleep state between the paging opportunities.
20. A device according to any one of the preceding clauses when dependent on any one of clauses 16 to 19 wherein the first maximum interval is determined by a difference between a duration of the cycle and a duration of the paging phase.
21. A device according to clause 20 wherein the second maximum interval is less than a difference between the duration of the cycle and the duration of the paging phase duration of the first mode.
22. A device according to of any one of the preceding clauses wherein the modem operates in an eDRX mode when the device is in the first mode.
23. A device according to any one of the preceding clauses, wherein the modem operated in a DRX mode for at least a part of a time in which the device is in the second mode.
24. A device according to clause 23 wherein the DRX mode is operated when the modem is in a Radio Resource Control (RRC) idle mode.
25. A device according to any one of the preceding clauses wherein in response to the operator requested arming state for the device that is stored on the device when the event is detected by the sensor being an armed state, the device:
   ends operating in the first mode and configures the modem to operate in a communications mode to determine whether the arming state for the device that is stored on the device is consistent with a remotely set arming state that had not been stored on the device when the event was detected by the sensor is an armed state;
   in response to the armed state being inconsistent returning to operating in the first mode sooner than if the armed state is consistent.
26. A device according to any one of the preceding clauses, wherein in response to the condition not being satisfied, the device determines not operate in the second mode in response to the detected event. For example, the device may continue to operate in the first mode if it had not left the first mode or it may return to the first mode if it had left the first mode.
27. A device according to any one of the preceding clauses, wherein upon expiry of the waiting period the device returns to the first mode.
28. A device according to any one of the preceding clauses, wherein the waiting period has a duration that has predefined default length. In some embodiments the default length is at least 3 minutes, e.g. at least 5 minutes.
29. A device according to any one of the preceding clauses, wherein the waiting period is initially no more than 10 minutes. In an embodiment, the waiting period is 7 minutes.
30. A device according to clause 28, wherein the default length is defined by a range (e.g. the device may control the default length to be at least a predefined minimum and no more than a predefined maximum).
31. A device according to the clause 30, wherein in response to receiving, during at least a portion of the waiting period, an operator command via the cellular modem that dismisses the device from operating in the second mode, the device is configured to end the waiting period by reducing the duration to less than the default length.
32. A device according to the clause 31, wherein the operator command via the cellular modem that dismisses the device from operating in the second mode comprises a disarm command.
33. A device according to any one of the preceding clauses, wherein in response to receiving, during the waiting period, an operator command to perform an action, the device performs the action.
34. A device according to clause 33, wherein the action comprises performing one or more or each of: operating a microphone on the device; and operating a device that has a field of view.
35. A device according to clause 34, wherein the device having a field of view comprises a camera.
36. A device according to any one of the preceding clauses wherein when the device is in the second mode there is a reduced maximum latency for the device to receive data via the cellular modem compared with when the device is in the first mode.
37. A device according to any one of the preceding clauses, wherein for an operator command of at least one type, upon receiving the operator command within at least a portion of the waiting period, the device is configured to extend the waiting period.
38. A device according to clause 37, wherein the at least one type of command comprises a command to perform a response action.
39. A device according to clause 37 or 38, wherein the at least one type of command comprises an explicit command to extend the waiting period.
40. A device according to any one of the preceding clauses, wherein in response to receiving, during the waiting period, an operator command to perform an action comprising a deterrent action, the device is configured to perform the deterrent action.
41. A device according to clause 40, wherein the deterrent action comprises emitting visible-light obscuring matter.
42. A device according to clause 40 or 41, wherein in response to receiving, during the waiting period, an operator command to perform an action comprising a deterrent action, the device extends the waiting period.
43. A device according to any one of clause 40 to 42, wherein after performing the deterrent action, the device is configured to operate a camera on the device to capture an image.
44. A device according to any one of the preceding clauses wherein the sensor comprises a motion detector.
45. A device according to any one of the preceding clauses wherein in response to the detecting of the event, then conditional upon the operator requested arming state for the device that is stored on the device when the event is detected by the sensor being an armed state, the device performs a verification action to verify the event.
46. A device according to any one of the preceding clauses wherein in response to said condition being satisfied, the device performs a verification action to verify the event.
47. A device according to clause 45 or 46 wherein the verification action comprises operating a camera on the device to capture an image.
48. A device according to any one of the preceding clauses, wherein in response to the detecting of the event, then conditional upon an arming state setting indicating the device is armed, the device triggers a siren to sound an alarm.
49. A device according to clause 48, wherein the arming state setting is further determined using an arming state identifier received by the device via the cellular modem after the detecting of the event.
50. A device according to any one of the preceding clauses wherein the device does not transmit signals via the cellular modem while in the first mode.
51. A device according to any one of the preceding clauses wherein while the device is in the first mode the modem is always idle with respect to the cellular network.
52. A device according to any one of the preceding clauses wherein the device transitions to the second mode by detaching from the cellular network and then instructing the modem to reattach to the cellular network with a request to a cellular core network of the cellular network to synchronize cellular communications with the modem in accordance with the second mode.
53. A device according to any one of the preceding clauses wherein after operating in the second mode the device returns to operating in the first mode by detaching from the cellular network and then instructing the modem to reattach to the cellular network with a request to a cellular core network of the cellular network to synchronize cellular communications with the modem in accordance with the first mode.
54. A device according to any one of clauses 1 to 53, wherein the device operates in the second mode by repeatedly transmitting signals with a maximum interval between respective signal transmissions, wherein each signal transmission commences or prolongs an RRC connected mode so that the modem is continuously able to receive cellular communications or is operated to maintain the second maximum interval.
55. A device according to clause 54 wherein the device is configured to switch between the first and second modes without detaching and reattaching to the cellular network.
56. A device according to any one of the preceding clauses wherein in response satisfaction of a criterion comprising that an operator requested arming state for the device that is stored on the device when the event is detected by the sensor is an armed state, the device transmits an event notification, via the cellular modem, the event notification identifying the detection of the event.
57. A device according to clauses 56 wherein the criterion is that the operator requested arming state for the device that is stored on the device when the event is detected by the sensor is an armed state.
58. A device according to clauses 56 or 57 wherein the criterion further comprises that an arming state identifier received by the device after the detecting of the event but determined by an operator request before the detected event corresponds to an armed state.
59. A system comprising a security response device in accordance with any one of clause 56 to 58 and further comprising a server, wherein the server is configured to receive the event notification and in response, or conditional upon an arming state for the device stored on the server that had not been known by the device when the event was detected corresponding to an armed state, the server is configured to transmit an alert for an operator device.
60. A system according to clause 59, wherein the server is configured to determine an expected expiry time of the waiting period and transmit a timing parameter for reception by the operator device for configuring the operator device, the timing parameter being correlated with the expected expiry of the waiting period.
61. A system according to clause 60, wherein the timing parameter represents a time that is earlier than a time of the expected expiry of the waiting period.
62. A system according to any one of clauses 59 or 61, wherein the server is operable to receive an arming state request by the operator device, the arming state request identifying an intended arming for the security device, wherein upon receiving the arming state request, the server is, at least if the intended arming state is different to a most-recently stored arming state, transmit an indication of the intended arming state for the security device.
63. A system according to any one of clauses 59 to 62 wherein the system further comprises at least one non-transient computer readable medium for storing instructions for executing by a processor of the operator device, wherein by executing the instructions the processor is configured to receive the alert via a communications module and in response to receiving the alert, configure an interface of the operator device to present an indication of the alert.
64. A system according to clause 63 wherein by executing the instructions the processing system is further configured to configure an interface of the operator device to display a remaining time for the operator to respond to the alert.
65. A system according to clause 63 or 64 wherein by executing the instructions the processing system is further configured to configure an interface of the operator device to display a selectable option for the operator, wherein upon the operator selecting the option, the processing system is configured to instruct the communications module to transmit an indication of the selected option for the server,
   wherein the server, in response to receiving indication of the selected option, is configured to transmit a corresponding message for the security device,
   wherein the security device, upon receiving the corresponding message extends the waiting period.
66. A method for operating a security device, the security device comprising:
   a cellular modem for establishing a communications channel between the device and a base station of a cellular network; and
   a sensor for detecting an event within a monitored environment;
   wherein the device is operable in a first mode in which there is a first maximum interval between successive times at which the modem is able to receive cellular communications;
wherein the method comprises:
   in response to satisfaction of a condition, the operating in a second mode in which the modem is continuously able to receive cellular communications or in which there is a second maximum interval between successive times at which the modem is able to receive cellular communications, wherein the second maximum time is shorter than the first maximum time interval, and the remaining in second mode for a waiting period to enable receipt of an operator command via the cellular modem,
   wherein the condition comprises that an operator requested arming state for the device that is stored on the device when the event is detected by the sensor is an armed state.
67. A non-transient computer readable medium comprising code for executing by a processor of a security device, the processor configuring the security device to perform the method of clause 66.
68. A computer-implemented method for use with a security device comprising:
   a cellular modem for establishing a communications channel between the device and a base station of a cellular network;
   a sensor for detecting an event within a monitored environment; and
   a memory for storing an operator requested arming state; the method comprising:
   operating the device in a first mode in which the operator requested arming state is updatable via the cellular modem with a regularity that is limited by a first maximum time interval; and
   in response to satisfaction of a condition, operating the device in a second mode in which the modem is continuously able to receive cellular communications or in which there is a second maximum interval between successive times at which the modem is able to receive cellular communications, wherein the second maximum time is shorter than the first maximum time interval, and the device remains in second mode for a waiting period to enable receipt of an operator command via the cellular modem,
   wherein the condition comprises that an operator requested arming state for the device that is stored on the device when the event is detected by the sensor is an armed state.
69. A non-transient computer readable medium comprising code for executing by a processor of a security device, the processor configuring the security device to perform the method of clause 68.

Any of the device clauses referred to herein are also applicable to the method clause 66 or 68 or to the non-transient computer readable medium clause 67 or 69, with appropriate corresponding features.

The embodiments described above are intended to be indicative, and are not limiting on the scope of protection sought, which should be determined on the basis of the claims appended hereto.

1. A security device comprising:
a cellular modem for establishing a communications channel between the device and a base station of a cellular network; and
a sensor for detecting an event within a monitored environment;
wherein the device is operable in a first mode in which there is a first maximum interval between successive times at which the modem is able to receive cellular communications from the cellular network;
wherein in response to satisfaction of a condition, the device operates in a second mode in which the modem is continuously able to receive cellular communications from the cellular network or in which there is a second maximum interval between successive times at which the modem is able to receive cellular communications from the cellular network, wherein the second maximum time is shorter than the first maximum time interval, and the device remains in second mode for a waiting period to enable receipt of an operator command via the cellular modem,
wherein the condition comprises that an operator requested arming state for the device that is stored on the device when the event is detected by the sensor is an armed state.

2. The device according to claim 1, wherein, in response to the operator requested arming state for the device that is stored on the device when the event is detected by the sensor being an armed state, the device modem operates in a communications mode to determine whether the arming state for the device that is stored on the device is consistent with a remotely set arming state that had not been stored on the device when the event was detected by the sensor is an armed state, wherein the condition further comprises that the arming state for the device that is stored on the device is consistent with a remotely set arming state that had not been stored on the device when the event was detected by the sensor is an armed state.

3. The device according to claim 1, wherein the operator requested arming state for the device is based on a communication received via the cellular modem.

4. The device according to claim 3, wherein the communication was received following a paging communication to the device from the cellular network, wherein the paging communication was received by the device while the device operated in the first mode.

5. (canceled)

6. The device according to claim 1, wherein the first maximum time interval comprises a power conserving period in which the modem is an off or sleep state and the second maximum time is shorter than the power conserving period.

7. The device according to claim 6, wherein in response to detecting the event during the power conserving period, the device ends operating in the first mode before an expiry of the power conserving period to enter the modem into a communications mode to at least one of:
determine whether the arming state for the device that is stored on the device is consistent with a remotely set arming state that had not been stored on the device when the event was detected by the sensor is an armed state; and
transmit a notification of the detected event.

8. The device according to claim 1, wherein the first maximum time interval comprises a power conserving period in which the modem is an off or sleep state and the second maximum time is shorter than the power conserving period, wherein the device is configured to obtain updates to the arming state without interrupting the power conserving period.

9. The device according to claim 1, wherein the modem operates in an eDRX mode when the device is in the first mode.

10. The device according to claim 1, wherein in response to the operator requested arming state for the device that is stored on the device when the event is detected by the sensor being an armed state, the device:
ends operating in the first mode and configures the modem to operate in a communications mode to determine whether the arming state for the device that is stored on the device is consistent with a remotely set arming state that had not been stored on the device when the event was detected by the sensor is an armed state;
in response to the armed state being inconsistent returning to operating in the first mode sooner than if there the armed state is consistent.

11. The device according to claim 1, wherein when the device is in the first mode the modem operates a cycle comprising an extended sleep phase and a paging phase.

12. (canceled)

13. The device according to claim 11, wherein when the device is in the first mode the modem is able to receive cellular communications only during a paging opportunity of a plurality of predetermined paging opportunities in the paging phase.

14. (canceled)

15. (canceled)

16. The device according to claim 1, wherein for an operator command of at least one type, upon receiving the operator command within at least a portion of the waiting period, the device is configured to extend the waiting period.

17. The device according to claim 1, wherein in response to said condition being satisfied, the device performs a verification action to verify the event.

18. The device according to claim 8, wherein the modem operated in a DRX mode for at least a part of a time in which the device is in the second mode.

19. The device according claim 1, wherein the first maximum time window is no less than 20 seconds, wherein the first maximum time window is no more than 164 seconds.

20. The device according to claim 1, wherein the second maximum time window is no more than 6 seconds.

21. The device according to claim 1, wherein in response to receiving, during the waiting period, an operator command to perform an action comprising a deterrent action, the device is configured to perform the deterrent action, wherein the deterrent action comprises emitting visible-light obscuring matter.

22. The device according to claim 1, wherein the device transitions to the second mode by detaching from the cellular network and then instructing the modem to reattach to the cellular network with a request to a cellular core network of the cellular network to synchronize cellular communications with the modem in accordance with the second mode.

23. A method for operating a security device, the security device comprising:
a cellular modem for establishing a communications channel between the device and a base station of a cellular network; and
a sensor for detecting an event within a monitored environment;
wherein the device is operable in a first mode in which there is a first maximum interval between successive times at which the modem is able to receive cellular communications;
wherein the method comprises:
in response to satisfaction of a condition, the operating in a second mode in which the modem is continuously able to receive cellular communications or in which there is a second maximum interval between successive times at which the modem is able to receive cellular communications, wherein the second maximum time is shorter than the first maximum time interval, and the remaining in second mode for a waiting period to enable receipt of an operator command via the cellular modem,
wherein the condition comprises that an operator requested arming state for the device that is stored on the device when the event is detected by the sensor is an armed state.

24. A non-transient computer readable medium comprising code for executing by a processor of a security device, the processor configuring the security device to perform the method of claim 23.
